(19) United States
(12) Patent Application Publication
(10) Pub. No.: US 2017/0291623 A1
(43) Pub. Date: Oct. 12, 2017

(54) Motorcycle Carrier with Retractable Wheels

(71) Applicant: JAMES D. DEES, PHOENIX, AZ (US)

(72) Inventor: JAMES D. DEES, PHOENIX, AZ (US)

(21) Appl. No.: 15/485,187

(22) Filed: Apr. 11, 2017

Related U.S. Application Data
(60) Provisional application No. 62/321,162, filed on Apr. 11, 2016.

(51) Int. Cl. B62B 3/02; B62B 3/10

(52) U.S. Cl. CPC B62B 3/02; B62B 3/10; B62B 3/04

(57) ABSTRACT

A motorcycle carrier with retractable wheels. The present example provides a motorcycle carrier with retractable wheels (carrier) is a structure that allows a motorcycle to be parked on it and secured safely, typically during shipping or storage. The carrier may include wheels that may be extended to aid in moving a motorcycle stored on the carrier. The wheels may be retracted when the motorcycle is no longer being moved. When secured the carrier may also function as a work stand.

### CROSS-REFERENCE TO RELATED APPLICATION(S)

This application claims the benefit of U.S. Provisional Patent Application No. 62/321,162 filed Apr. 11, 2016, the contents of which are hereby incorporated by reference.

### TECHNICAL FIELD

This description relates generally to transport carriers and more specifically to those for shipping or transporting motorcycles.

### BACKGROUND

Transporting two wheeled vehicles such as motorcycles can be difficult. It can be difficult to keep then upright and undamaged during transport. Also moving a heavy object on two wheels can be a challenge when it is unpowered. One faces the combined difficulties of moving dead weight that may only be being kept in an upright position by a kick, or center stand. It would be desirable to have a device that keeps a motorcycle upright for transport and tends to protect it from damage. Also such a device would advantageously allow the motorcycle frame combination to be easily moved, and loaded onto transport.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a motorcycle carrier with retractable wheels (carrier) is a structure that allows a motorcycle to be parked on it and secured safely, typically during shipping or storage. The carrier may include wheels that may be extended to aid in moving a motorcycle stored on the carrier. The wheels may be retracted when the motorcycle is no longer being moved. When secured the carrier may also function as a work stand.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows the motorcycle carrier with retractable wheels supporting a motorcycle being transported by a flatbed truck.

FIG. 2 shows the motorcycle carrier with retractable wheels supporting a motorcycle being transported in a box truck

FIG. 3 shows the motorcycle carrier with retractable wheels in a pickup truck.

FIG. 4 shows a motorcycle being driven onto the motorcycle carrier with retractable wheels so that it may be secured for transport.

FIG. 5 shows a motorcycle secured to the motorcycle carrier with retractable wheels prior to loading onto a vehicle for transport.

FIG. 6 shows a side view of the motorcycle carrier with retractable wheels, with the wheels deployed so that the carrier will roll.

FIG. 7 is an end view of the motorcycle carrier with retractable wheels, as seen from the end where a motorcycle would enter the carrier.

FIG. 8 is a line drawing of the motorcycle carrier with retractable wheels as viewed from the top.

FIG. 9 is a line drawing of the motorcycle carrier with retractable wheels as viewed from the side.

FIG. 10 is a detailed view of the wheels operation in the motorcycle carrier with retractable wheels of FIGS. 8 and 9.

FIG. 11 shows a front view of the carrier with a motorcycle mounted on the carrier, and shows the lever as used to raise and lower the wheels on the carrier.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

This is a description of a motorcycle carrier (or equivalently “pallet” or simply “carrier”) which is used for the safe and secure transportation of a motorcycle or other objects which need to be secured for moving. The examples below describe a motorcycle carrier. Although the present examples are described and illustrated herein as being implemented in a trucking system, the system described is provided as an example and not a limitation. As those skilled in the art will appreciate, the present examples are suitable for application in a variety of different types of transport systems.

The motorcycle carrier with retractable wheels (carrier) is a structure that allows a motorcycle to be parked on it and secured safely, typically during shipping or storage. The carrier may include wheels that may be extended to aid in moving a motorcycle stored on the carrier. The wheels may be retracted when the motorcycle is no longer being moved. When secured the carrier may also function as a work stand.

In alternative examples provisions for the use of hooks and additional securement locations may be provided.

In use the carrier sits flat on the ground with the wheels withdrawn. The motorcycle is pushed or driven onto the pallet and secured in place with straps or the like. Next the pallet is elevated onto its wheels by cranking them down, or otherwise causing them to be extended. Now the motorcycle and carrier are on wheels, and may easily be loaded (by rolling) onto a tow truck or flatbed truck. Once loaded or otherwise located, the wheels are retracted to keep the carrier and motorcycle in place.

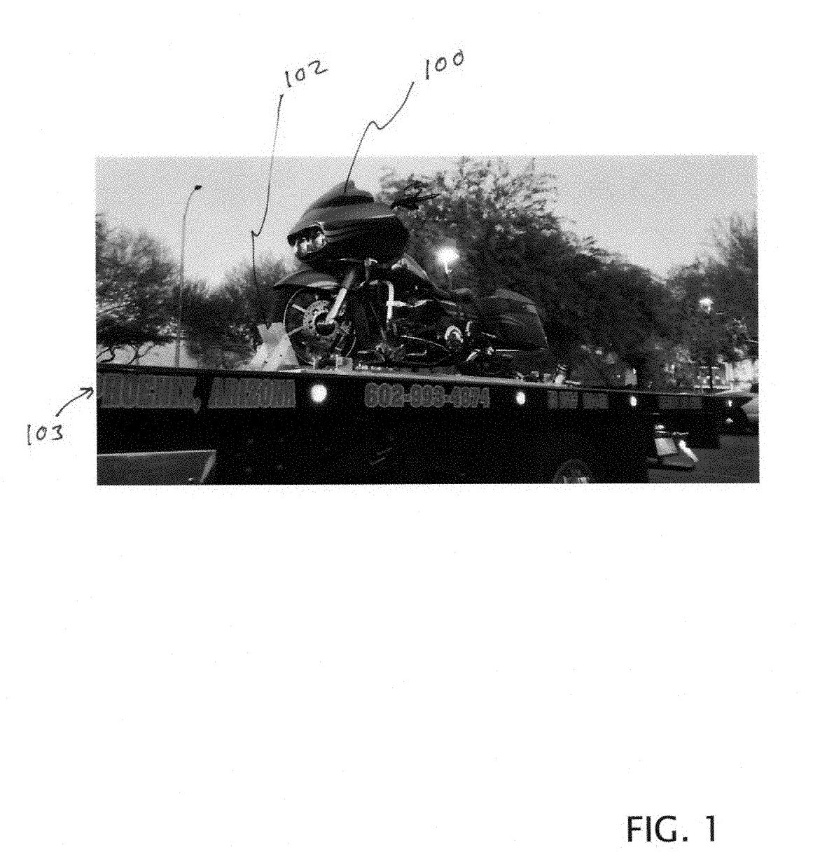

FIG. 1 shows the motorcycle carrier with retractable wheels 102 supporting a motorcycle 100 being transported by a flatbed truck 103.

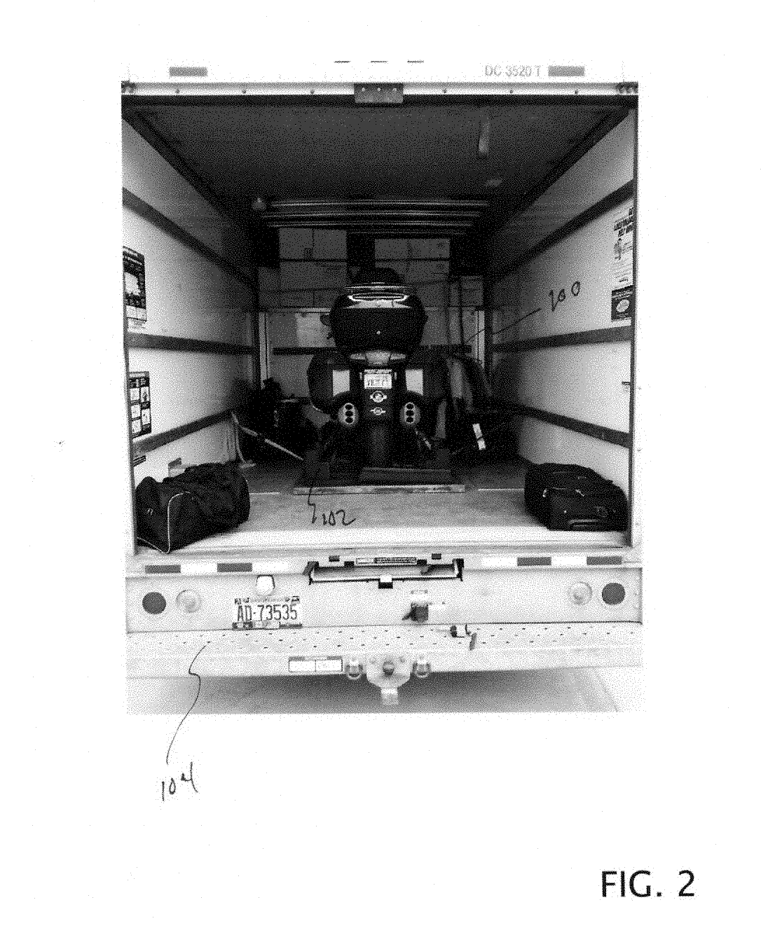

FIG. 2 shows the motorcycle carrier with retractable wheels 102 supporting a motorcycle 100 being transported in a box truck 104.

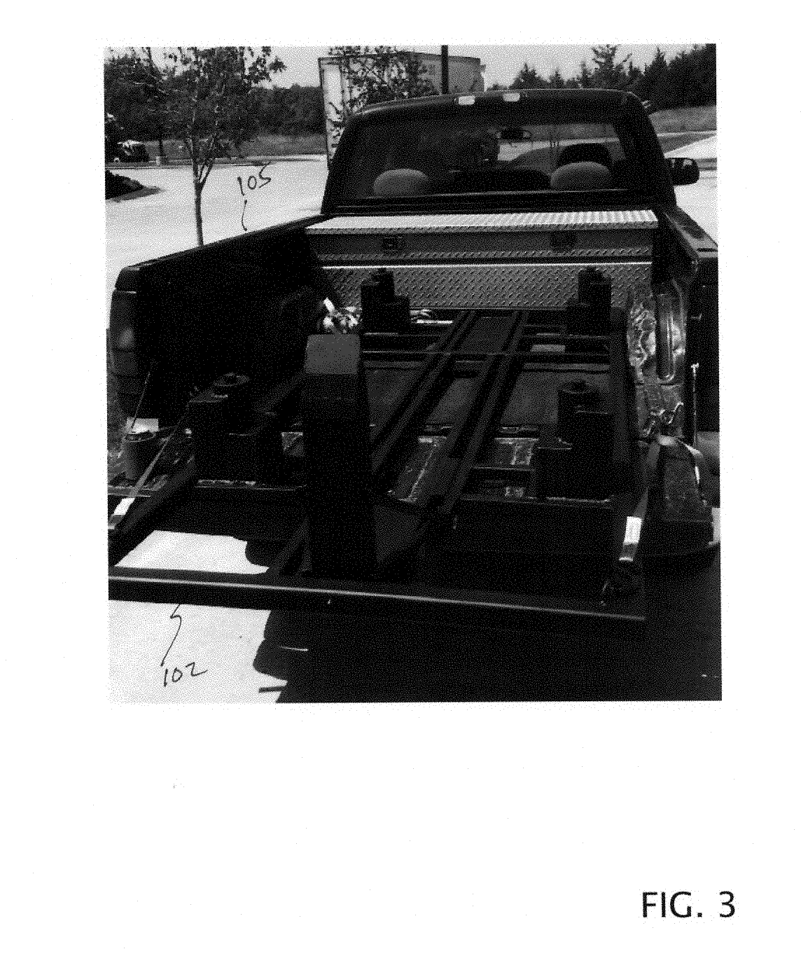

FIG. 3 shows the motorcycle carrier with retractable wheels 102 in a pickup truck 105.

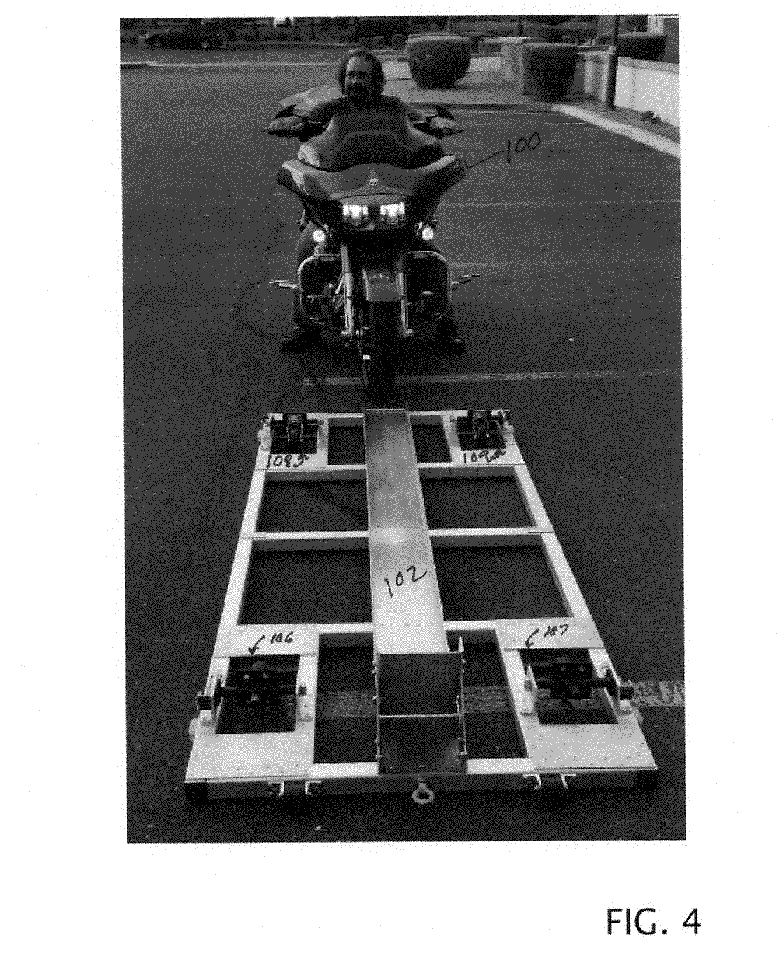

FIG. 4 shows a motorcycle 100 being driven onto the motorcycle carrier with retractable wheels 102 so that it may be secured for transport. First the motorcycle is driven onto the carrier (with its wheels 106, 107, 108, 109 retracted) and then secured. The wheels may be then lowered to assist in moving the carrier/motorcycle combination, such as loading it onto a truck. Once the motorcycle is in placed on a tow vehicle, the wheels are retracted, to the pallet itself is on the ground, and will not roll. Then the whole system is strapped down for safety during transit. This system and also be used with trucking companies moving bikes from a dock to a trailer will be easy, then wheels retracted for safe shipping once strapped into place.

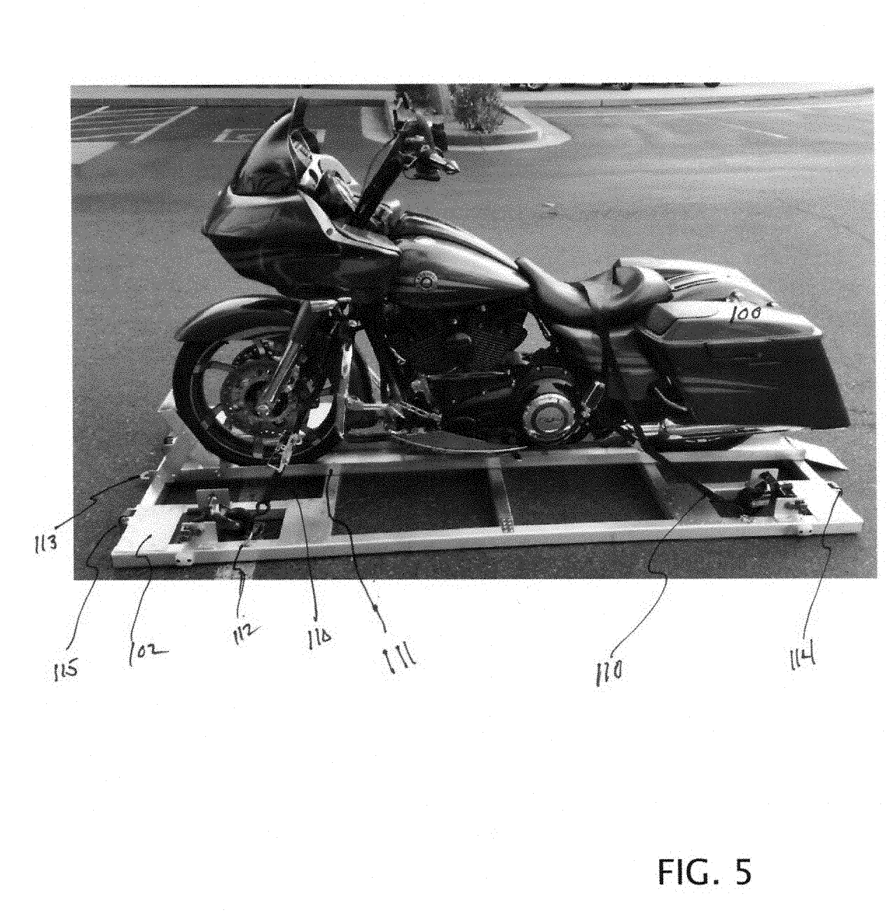

FIG. 5 shows a motorcycle 100 secured to the motorcycle carrier with retractable wheels 102 prior to loading onto a vehicle for transport. Strapping 110 or other hold-downs may be used to steady the motorcycle whose wheels rest in a central channel 111. The straps typically attach to eyelets 112 or equivalent on the carrier. Here the wheels are retracted so that the motorcycle does not roll while it is being prepared for shipment.

The unit may also be moved by lifting the front of the rack via attachment points provided 113, and rolled on rear wheels 114. Front wheels 115 may be provided to assist the carrier as it advances up a ramp. Such an arrangement would be useful in winching the motorcycle and carrier up a ramp into a truck bed

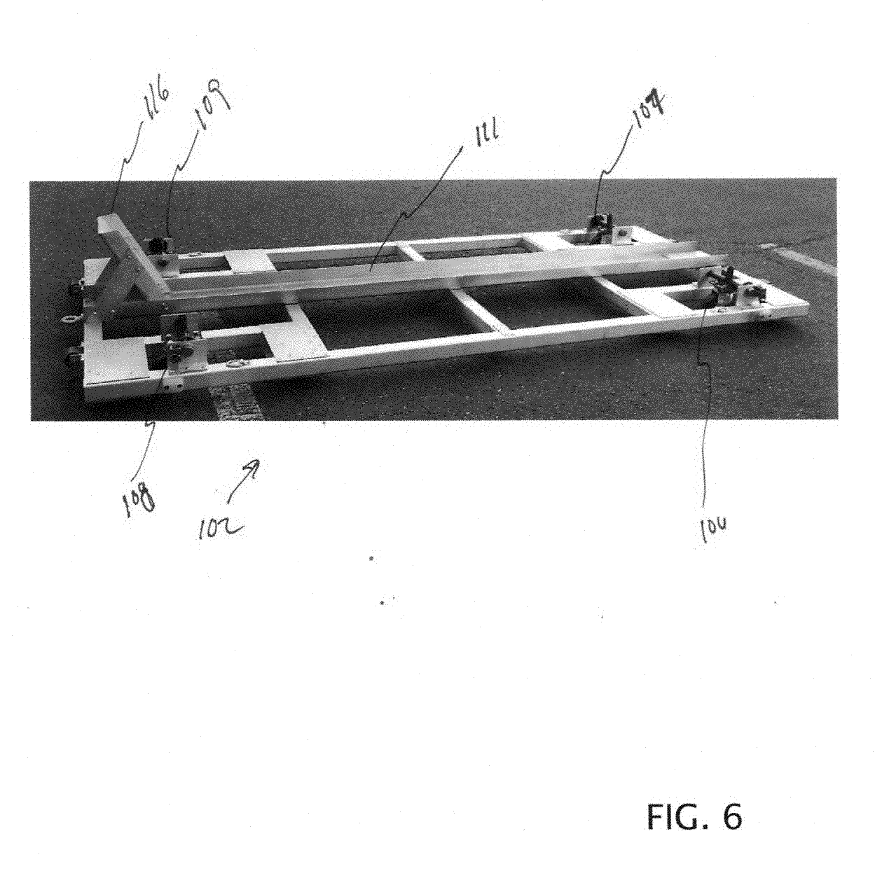

FIG. 6 shows a side view of the motorcycle carrier with retractable wheels 106, 107, 108, 109, with the wheels deployed so that the carrier will roll. As shown the wheels are generally at the four corners of the frame and the frame has a central channel 111 with a stop 116 at one end. The opposite end of the channel has a foldable ramp (not shown) to aid in driving the motorcycle onto the ramp. Openings in the frame facilitate loading the motorcycle as the kickstand can be lowered until the motorcycle is secured then retracted. Also the openings allow a person to sit on the motorcycle and move it about by allowing their foot to push against the ground, rather that pushing the motorcycle/carrier combination.

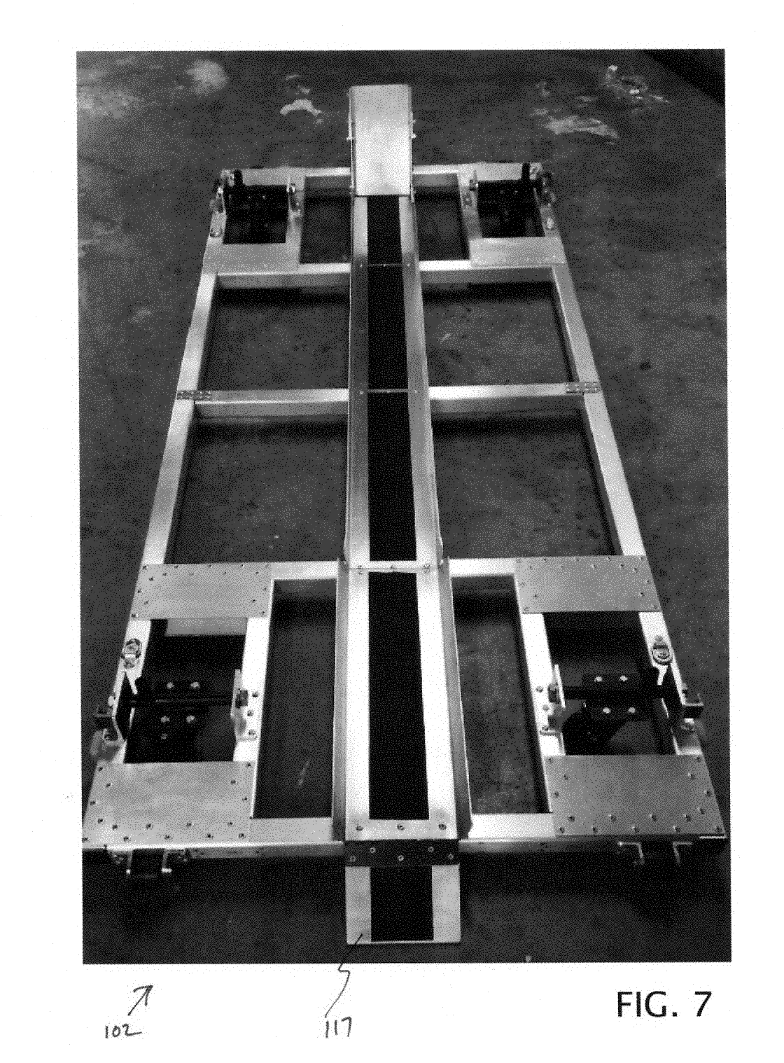

FIG. 7 is an end view of the motorcycle carrier with retractable wheels 102, as seen from the end where a motorcycle would enter the carrier. In this view the folding ramp 117 is seen. Also the wheels are extended so that the empty rack may be rolled around.

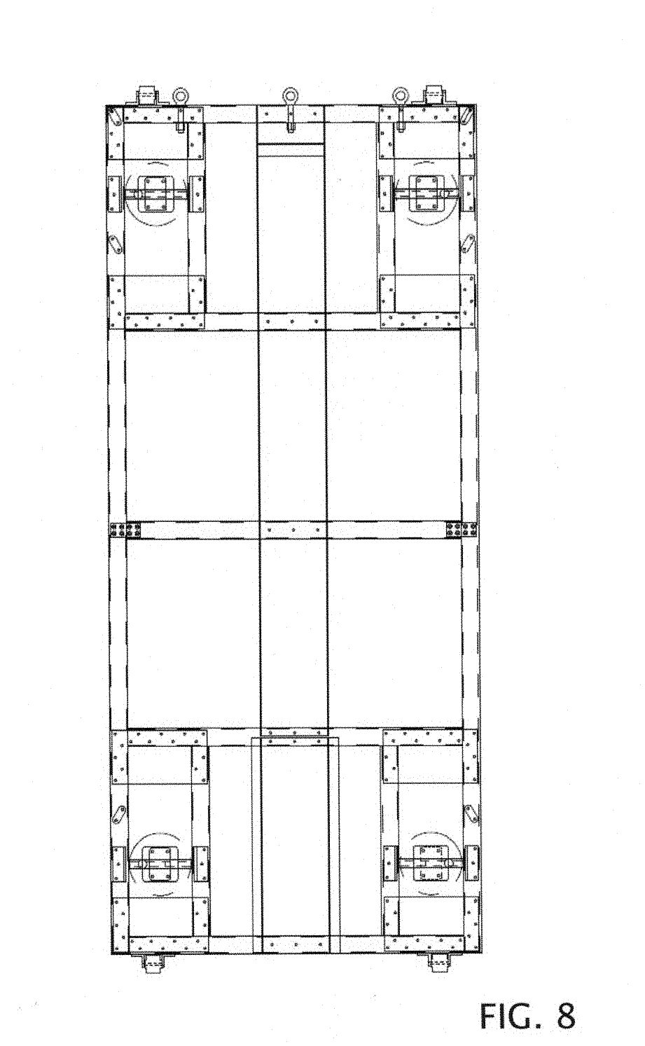

FIG. 8 is a line drawing of the motorcycle carrier with retractable wheels as viewed from the top.

This is a basic design of a light weight metal rectangle built with braces to eliminate flexing size can vary to use. The wheels retract so that the pallet is completely flat on the ground and easy to load motorcycles and materials without the pallet rolling beneath. Once a motorcycle, any other item is loaded onto the pallet, it can be secured using the multiple securement locations (D-rings, hooks, loops, etc.).

Near each of the 4 corners is 1 fully rotatable wheel which can be extended to elevate the pallet above the ground. The lift height can be altered on different pallets as needed by the demands of the customer. These wheels are heavy duty castor type wheels and durable. They retract when the pallet needs to be on the ground, and are used when the pallet needs to be moved. A motorcycle that is on a pallet can then be pushed, pullet, towed, or winched. Also good for machinery or other items.

The pallet is roughly 2 pallets in size but can vary greatly depending on the customer. The average pallet is 40-42 inches x 48 inches. So our pallet can be roughly 40 x 96 inches. More or less. The importance is the lateral stability and keeping enough width that the pallet will not tip over, and also wide enough that a motorcycle and have straps (tie downs) to many locations on the pallet. Securing the bike and eliminating the risk of motorcycle damage during shipping.

The front and rear of the pallet has tow hooks, and eyes, making towing with a cable hook, or chain an easy process. Also on the leading and following edges of the pallet are rollers which will hit the angle of a ramp or other obstruction in front or behind the pallet, to keep the metal from dragging on the ground. The rollers are especially handy when using a roll back tow truck. The angle of the bed in relation to the ground would normally have metal to the ground, not the entire system rolls on wheels for easy rolling during loading and unloading.

The frame itself at this time is rectangular in shape, and is made as light weight as possible using aluminum. The current model is built with square tubing, yet there is no reason that I-beam, angle iron, round tubing and other shapes cannot be used so long as the unit won't flex when tightly strapped and during loading/unloading and in transit. Safety of the secured item is the main concern.

The frame may be built of lightweight aluminum or equivalent material, so that it is easy to transport, and easy to store. The carrier frame is typically rectangular, but may be made in any convenient shape to keep the motorcycle upright and protected. The exemplary carrier shown herein in the attached pictures is 40×96 inches. However various sizes for different sized motorcycles may be constructed. Typically in a center portion of the carrier support mechanism is provided to keep the motorcycle upright and secured. The motorcycle is typically driven or pushed onto the carrier, where it is then secured to the carrier by straps, cords or the like. To aid in driving on, a ramp or other aid may optionally be provided. And to prevent the motor cycle from going too far a bump stop chock may also be provided. Such a chock may also be removable, and may also help keep the motorcycle upright.

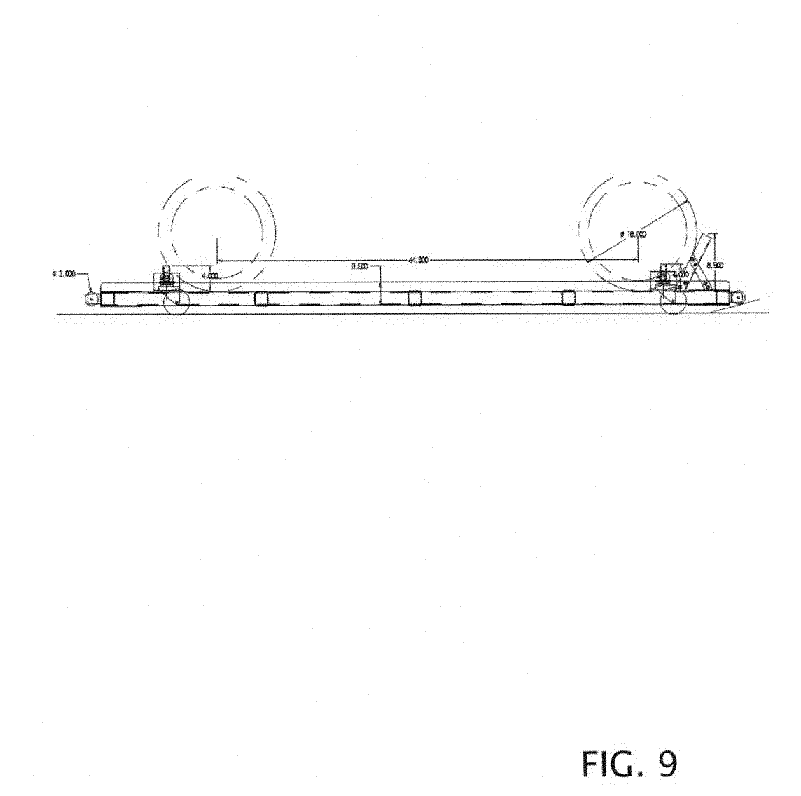

FIG. 9 is a line drawing of the motorcycle carrier with retractable wheels as viewed from the side.

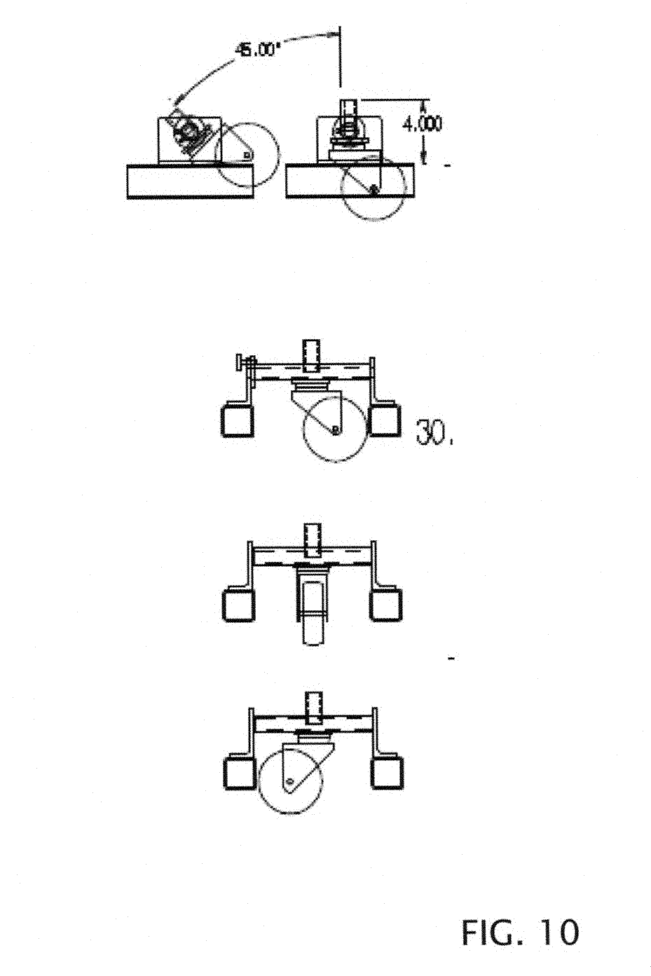

FIG. 10 is a detailed view of the wheels operation in the motorcycle carrier with retractable wheels of FIGS. 8 and 9. As can be seen the wheels fold to the side when retracted, and may be extended by a lever in this example until an internal detent or other locking mechanism known to those skilled in the art is engaged.

In alternative examples the wheels may crank down utilizing a typical crank mechanism that allows the height to be adjusted, and holds the position of the wheels at a desired height. Alternatively the wheels may be extended to a fixed position, as may be desired. Also the wheels may be individually extended down. Alternatively one or more wheels may have their lowering and retracting mechanisms mechanically coupled so that one mechanism may control the raising or lowering of more than one wheel. The wheels themselves are typically wheels of sufficient size to roll easily.

The wheels themselves are typically of a caster type, or equivalent so that the carrier may be pushed in any direction desired. The rolling feature is advantageous when using the carrier in tow trucks, repair shops, or the like. Three or more wheels as desired may be used. Also position of the wheels may be varied as desired. For example for carriers pushed up ramps the wheels may be positioned at the front and back to keep the rack frame from hanging up on the ramp as the carrier transitions from being pushed across a flat floor to up a ramp and into a truck. Also the wheel height may be adjusted for such situations.

The carrier may also be enclosed or fitted with a rigid cover to protect the motorcycle from dirt, moisture, damage or the like during transport or storage.

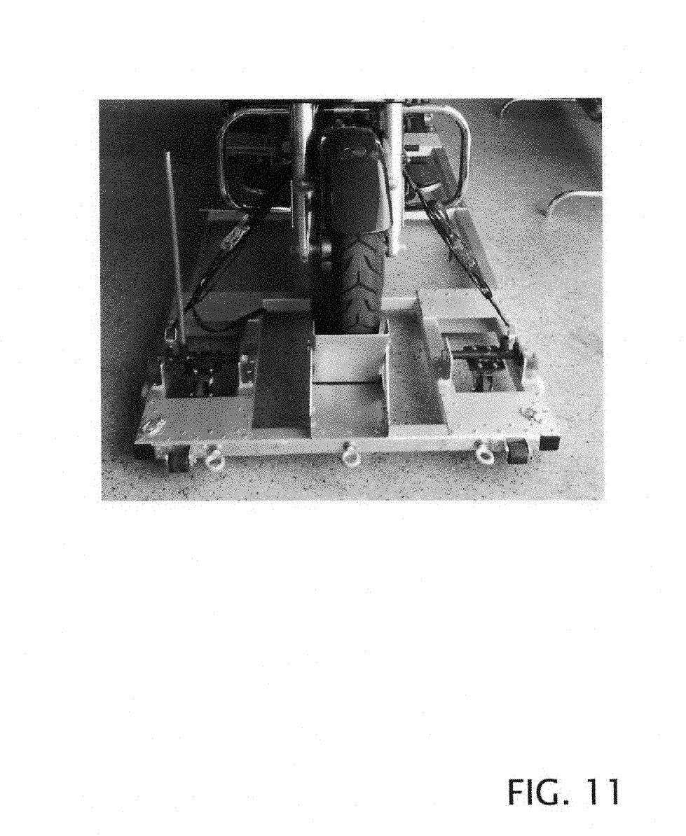

FIG. 11 shows a front view of the carrier with a motorcycle mounted on the carrier, and shows the lever as used to raise and lower the wheels on the carrier. Here through mechanisms known to those skilled in the art the lever causes the wheel to pivot about an axis, and then come to rest in a detent or other equivalent locking mechanism so that the wheels remain down and the motorcycle and carrier can be moved.

In further alternative examples the wheel retraction system may be configured by methods known to those skilled in the art to operate with just a foot, and doesn't involve bending over. In further alternative examples the carrier is constructed to separate into two or more pieces which can be stored on the tool boxes of tow vehicles and the like.

Those skilled in the art will realize that the process sequences described above may be equivalently performed in any order to achieve a desired result. Also, sub-processes may typically be omitted as desired without taking away from the overall functionality of the processes described above.

1. A motorcycle carrier comprising:
a generally rectangular frame including a center channel to accommodate motorcycle wheels; and
a plurality of retractable wheels mounted generally at the corners of the generally rectangular frame.

2. The motorcycle carrier of claim 1 in which the retractable wheels are operable by a lever.
